(19) United States
(12) Patent Application Publication
(10) Pub. No.: US 2023/0276079 A1
(43) Pub. Date: Aug. 31, 2023

(54) LIVE STREAMING ROOM PAGE JUMP METHOD AND APPARATUS, LIVE STREAMING ROOM PAGE RETURN METHOD AND APPARATUS, AND ELECTRONIC DEVICE

(71) Applicant: Beijing Bytedance Network Technology Co., Ltd., Beijing (CN)

(72) Inventors: Jiatian CAI, Beijing (CN); Yijie LI, Beijing (CN); Hao YAN, Beijing (CN); Xiaolong YANG, Beijing (CN); Bo DENG, Beijing (CN)

(21) Appl. No.: 18/312,475

(22) Filed: May 4, 2023

Related U.S. Application Data
(63) Continuation-in-part of application No. PCT/CN2021/128749, filed on Nov. 4, 2021.

(30) Foreign Application Priority Data
Nov. 4, 2020 (CN) 202011219515.2

(51) Int. Cl. H04N 21/2187; G06F 3/0485; G06F 16/954; G06F 16/957

(52) U.S. Cl. CPC H04N 21/2187; G06F 3/0485; G06F 16/954; G06F 16/957

(57) ABSTRACT

The present disclosure provides a live streaming room page jump method and apparatus, a live streaming room page return method and apparatus, and an electronic device, which relate to the field of live streaming. The live streaming room page return method includes: displaying a current live streaming room page of an application, and receiving a return instruction for the current live streaming room page; querying, based on the return instruction, page data corresponding to an immediately-previous-level page of the current live streaming room page in a predetermined storage container, the storage container being configured to store page data of one or more previous-level pages of the current live streaming room page; and loading the queried page data corresponding to the immediately-previous-level page, and returning to the immediately-previous-level page.

### CROSS-REFERENCE TO RELATED APPLICATION

The present application is a continuation-in-part of International Application No. PCT/CN2021/128749 filed on Nov. 4, 2021, which claims priority to Chinese Patent Application No. 202011219515.2, titled “LIVE STREAMING ROOM PAGE JUMP METHOD AND APPARATUS, LIVE STREAMING ROOM PAGE RETURN METHOD AND APPARATUS, AND ELECTRONIC DEVICE”, and filed on Nov. 4, 2020, the entire disclosure of which is incorporated herein by reference.

### FIELD

The present disclosure relates to the field of live streaming technologies, and more particularly, to a live streaming room page jump method and apparatus, a live streaming room page return method and apparatus, and an electronic device.

### BACKGROUND

With the continuous development of networks, application platforms for online live streaming are increasingly widespread. When watching a live streaming room page, a user may need to switch between live streaming room pages.

Currently, during switching between the live streaming room pages, switching to an immediately-next-level page means that data of a current live streaming room page will be deleted. When there is a need to return back, it is impossible to return to the live streaming room page prior to the page jump.

In view of this, it is essential to optimize the existing switching mode of the live streaming room page.

### SUMMARY

The SUMMARY is provided to introduce, in a brief form, the concept that will be described in detail in the following DETAILED DESCRIPTION. The summary is not intended to identify key features or essential features of the claimed technical solutions, nor is it intended to be used to limit the scope of the claimed technical solutions.

In a first aspect, a live streaming room page jump method is provided. The live streaming room page jump method includes: displaying a current live streaming room page of an application, and receiving a jump instruction of jumping to an immediately-next-level page; storing page data corresponding to the current live streaming room page into a predetermined storage container, the page data being used to return to the current live streaming room page in response to receiving a return instruction for the immediately-next-level page; and jumping to the corresponding immediately-next-level page based on the jump instruction.

In a second aspect, a live streaming room page return method is provided. The live streaming room page return method includes: displaying a current live streaming room page of an application, and receiving a return instruction for the current live streaming room page; querying, based on the return instruction, page data corresponding to an immediately-previous-level page of the current live streaming room page in a predetermined storage container, the storage container being configured to store the page data of the immediately-previous-level page of the current live streaming room page; and loading the queried page data corresponding to the immediately-previous-level page, and returning to the immediately-previous-level page.

In a third aspect, an electronic device is provided. The electronic device includes: one or more processors; a memory; and one or more application programs. The one or more application programs are stored in the memory, and are configured to be executed by the one or more processors to perform the live streaming room page jump method according to the first aspect of the present disclosure.

### BRIEF DESCRIPTION OF THE DRAWINGS

The above and other features, advantages, and aspects of the embodiments of the present disclosure will become more apparent in conjunction with the accompanying drawings and with reference to the following detailed description. Throughout the drawings, the same or similar reference numbers refer to the same or similar elements. It should be understood that the drawings are schematic, and elements and elements are not necessarily drawn to scale.

FIG. 1 is a schematic flowchart of a live streaming room page jump method according to an embodiment of the present disclosure.

FIG. 2 is a schematic diagram of a live streaming room page according to an example of the present disclosure.

FIG. 3 is a schematic diagram of a page jump according to an example of the present disclosure.

FIG. 4 is a schematic flowchart of a live streaming room page return method according to an embodiment of the present disclosure.

FIG. 5 is a schematic diagram of a change in a live streaming room page according to an example of the present disclosure.

FIG. 6 is a schematic diagram of a structure of a live streaming room page jump apparatus according to an embodiment of the present disclosure.

FIG. 7 is a schematic diagram of a structure of a live streaming room page return apparatus according to an embodiment of the present disclosure.

FIG. 8 is a schematic diagram of a structure of an electronic device enabling return of a live streaming room page according to an embodiment of the present disclosure.

### DETAILED DESCRIPTION

Embodiments of the present disclosure will be described in more detail below with reference to the accompanying drawings. While some embodiments of the present disclosure are illustrated in the drawings, it should be understood that the present disclosure may be embodied in various forms and should not be construed as limitations on the embodiments set forth herein, but rather are provided for a more complete and thorough understanding of the present disclosure. It should be understood that the drawings and the embodiments of the present disclosure are for illustration purposes only and are not intended to limit the scope of the present disclosure.

It should be understood that various steps recited in embodiments of the method of the present disclosure may be performed in a different order, and/or performed in parallel. Moreover, the embodiments of the method may include additional steps and/or omit performing the illustrated steps. The scope of the present disclosure is not limited in this respect.

A term “including” and variations thereof as used herein are open-ended, i.e., “including, but not limited to”. The term “based on” means “based at least in part on”. The term “one embodiment” means “at least one embodiment”; the term “another embodiment” means “at least one additional embodiment”; the term “some embodiments” means “at least some embodiment”. Relevant definitions for other terms will be given in the following description.

It should be noted that the terms “first”, “second”, and the like in the present disclosure are only used for distinguishing different apparatuses, modules, or units, and are not used for limiting the order or interdependence of the functions performed by the apparatuses, modules, or units.

It should be noted that term “a”, “an”, or “plurality of” in the present disclosure is illustrative rather than limiting, which shall be construed as “one or more” by that those skilled in the art, unless clearly indicated otherwise.

The names of messages or information exchanged between the apparatuses in the embodiments of the present disclosure are for illustrative purposes only, and are not intended to limit the scope of the messages or information.

The present disclosure provides a live streaming room page jump method and apparatus, a live streaming room page return method and apparatus, and an electronic device, in order to solve the above technical problems in the related art.

The following describes the technical solutions of the present disclosure and the way to solve the above technical problems in detail with specific embodiments. These specific embodiments may be combined with each other below, and details of the same or similar concepts or processes may not be elaborated in some embodiments. The embodiments of the present disclosure will be described below with reference to the accompanying drawings.

The live streaming room page jump and page return methods according to embodiments of the present disclosure may be used in a terminal. The terminal may be, but is not limited to, various personal computers, notebook computers, smart phones, tablet computers, and portable wearable devices.

According to an embodiment of the present disclosure, a live streaming room page jump method is provided. As illustrated in FIG. 1, the method may include the following actions.

At block S101, a current live streaming room page of an application is displayed, and a jump instruction of jumping to an immediately-next-level page is received.

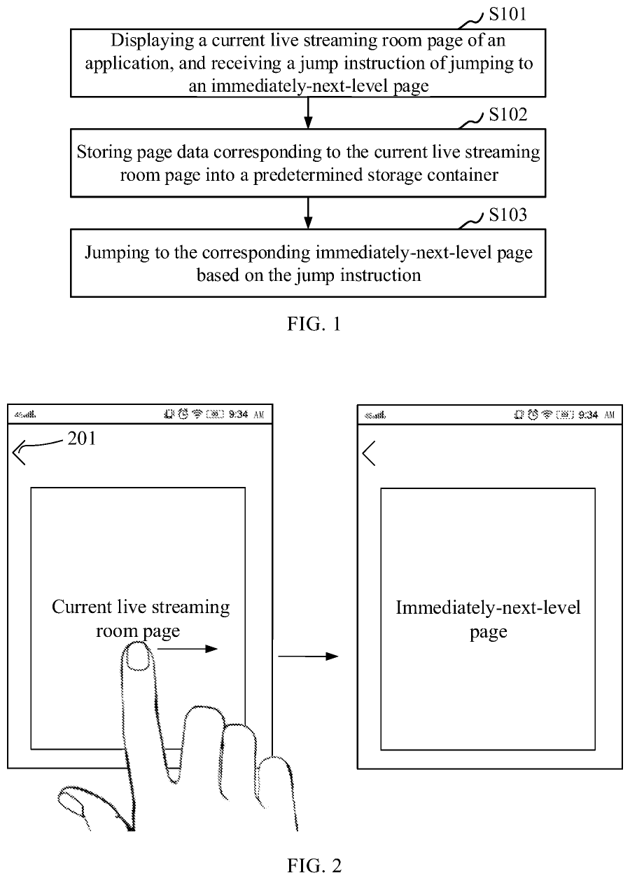

As illustrated in FIG. 2, a jump control 201 may be displayed on the current live streaming room page. The jump instruction may be generated in response to a user triggering the jump control 201, or may be generated by a touch gesture of the user. For example, the user can swipe rightwards or leftwards and jump to the immediately-next-level page. Additionally or alternatively, the user can swipe leftwards or rightwards and return to the immediately-previous-level page.

A link to the immediately-next-level page may also be displayed on the live streaming room page, and the jump instruction is generated when a click of the user on the link is received.

At block S102, page data corresponding to the current live streaming room page is stored into a predetermined storage container.

The page data is used to return to the current live streaming page in response to receiving the return instruction for the immediately-next-level page.

The storage container can be configured to store different types of page data. For example, it can store the page data corresponding to the live streaming room page, or page data corresponding to a web page, e.g., an H5 page.

At block S103, the corresponding immediately-next-level page is jumped to based on the jump instruction.

In some embodiments, the immediately-next-level page may be a live streaming room page, or may be a web page. That is, the jump can be performed between the live streaming room page and the web page.

In the above-mentioned embodiments, the page data corresponding to the current live streaming room page is stored in the predetermined storage container, and the page data is used for returning to the current page in response to receiving a return instruction for the immediately-next-level page, allowing return from the immediately-next-level page to the current live streaming room page prior to the page jump.

Further, the storage container can store both page data corresponding to the live streaming room page and page data corresponding to the web page. That is, both the jump operation and the return operation between the live streaming room page and the web page can be achieved.

In a possible implementation according to an embodiment of the present disclosure, the action at block S102 of storing page data corresponding to the current live streaming room page into a predetermined storage container may include: storing the page data corresponding to the current live streaming room page into the storage container based on a page level order corresponding to the current live streaming room page.

In some embodiments, when the page data is stored based on the page level order, data of an immediately-previous-level page corresponding to a page to be returned from may be returned to for each return.

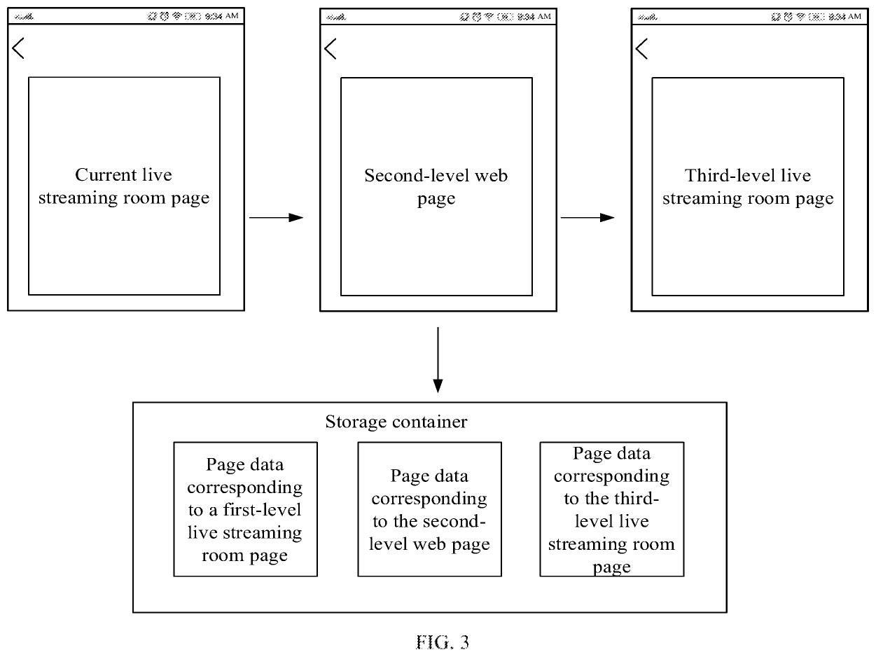

As illustrated in FIG. 3, in response to a first-level live streaming room page jumping to a second-level web page, page data corresponding to the first-level live streaming room page is stored in the storage container; in response to the second-level web page jumping to a third-level live streaming room page, web page data corresponding to the second-level web page is stored in the storage container. Thus, the third-level live streaming room page can return to the second-level web page; and the second-level web page can return to the first-level live streaming room page.

In a possible implementation, the second-level web page may be a live streaming room square page listing a number of recommended live streaming rooms for the user to choose from. Jumping from the first-level live streaming room page to the second-level web page may be triggered by the user swiping rightwards on the first-level live streaming room page. Jumping from the second-level web page to the third-level live streaming room page may be triggered by the user choosing one of the recommended live streaming rooms listed on the live streaming room square page.

In an embodiment, in addition to or instead of returning from the third-level live streaming room page to the second-level web page first and then to the first-level live streaming room page, the user may return from the third-level live streaming room page directly to the first-level live streaming room page.

In this case, the page data corresponding to the first-level live streaming room page stored in the storage container is also used for returning from the third-level live streaming room page directly to the first-level live streaming room page. That is, the page data corresponding to the current live streaming room page is also used for returning from an immediately-next-level live streaming room page of the current live streaming room page to the current live streaming room page, in response to receiving a return instruction for the immediately-next-level live streaming room page.

As compared with returning from the third-level live streaming room page to the second-level web page first and then to the first-level live streaming room page, the scheme of returning from the third-level live streaming room page directly to the first-level live streaming room page simplifies the user's operation and saves time, by skipping the second-level web page.

In a possible implementation according to an embodiment of the present disclosure, the immediately-next-level page is a live streaming room page; the action at block S103 of jumping to a corresponding immediately-next-level page based on the jump instruction may include: (1) determining a screen display state of a current live streaming room page; and (2) jumping to the corresponding immediately-next-level page based on the jump instruction, and displaying the immediately-next-level page based on the determined screen display state.

The screen display state may include full-screen display, non-full-screen display, comment region display, chat region display, etc.

In some embodiments, during jumping between the live streaming room pages, the screen display state prior to the page jump can be reserved. For example, when the current live streaming room page is in a state of full-screen display, the immediately-next-level page will be in a state of full-screen display; and when the current live streaming room page is in a state of non-full-screen display, the immediately-next-level page may also be in a state of non-full-screen, etc.

According to the above-mentioned live streaming room page return method, the page data corresponding to the current live streaming room page is stored in the predetermined storage container, and the page data is used to return to the current page in response to receiving the return instruction for the immediately-next-level page, such that the immediately-next-level page can return to the current live streaming room page prior to the page jump.

Further, the storage container can store both the page data corresponding to the live streaming room page and the page data corresponding to the web page. That is, both the jump operation and the return operation between the live streaming room page and the web page can be achieved.

An embodiment of the present disclosure provides a live streaming room page return method. As illustrated in FIG. 4, the live streaming room page return method may include the following actions.

At block S401, a current live streaming room page of an application is displayed, and a return instruction for the current live streaming room page is received.

The current live streaming room page may be provided with a return control. The return instruction may be obtained by the user triggering the return control, or may also be triggered based on a swipe operation of the user on the current live streaming room page. For example, the user may swipe leftwards or rightwards and return to the immediately-previous-level page. Additionally or alternatively, the user may swipe rightwards or leftwards and jump to the immediately-next-level page.

In an embodiment, the return control may be constantly displayed on the current live streaming room page. In this case, the user may trigger the return instruction by operating the return control.

Alternatively, the return control may be hidden when the current live streaming room page has been displayed for a certain period of time. In this case, when the display time period of the current live streaming room page exceeds a predetermined time period, the user may be interested in a live streaming content of the current live streaming room page, and the return control may be hidden. For example, when time display time period of the current live streaming room page exceeds 60 seconds, a return control at an upper left corner is hidden.

Optionally, instead of being hidden suddenly, the return control may disappear gradually. For example, when the display time period of the current live streaming room page exceeds 30 seconds, the return control at the upper left corner shrinks by a certain degree, for example, by a quarter, a half, etc. Then, when the display time period of the current live streaming room page exceeds 60 seconds, the return control at the upper left corner disappears completely, i.e., it is hidden.

In another embodiment, the current live streaming room page may be provided with both a first return control that can be hidden and a second return control that is constantly displayed. The first return control and the second return control are displayed at different positions on the the current live streaming room page and/or in different forms. In this case, even if the first return control has been hidden, the user can still trigger the return instruction by operating the second return control.

At block S402, page data corresponding to an immediately-previous-level page of the current live streaming room page in a predetermined storage container is queried based on the return instruction.

The storage container is configured to store the page data of one or more previous-level pages of a current live streaming room page.

A previous-level page may be a page prior to the current live-streaming room page to be jumped to, which may be the immediately-previous-level page of the current live-streaming room page, or may be an immediately-previous-level page of the immediately-previous-level page.

In some embodiments, the storage container can be configured to store the different types of page data. For example, it can store the page data corresponding to the live streaming room page, or the page data corresponding to the web page, e.g., the H5 page.

At block S403, the queried page data corresponding to the immediately-previous-level page is loaded, and the immediately-previous-level page is returned to.

In some embodiments, the immediately-previous-level page may be the live streaming room page, or may be the web page. That is, the jump can be performed between the live streaming room page and the web page.

In the above-mentioned embodiments, the page data of one or more previous-level pages of the current live streaming room page is stored in the storage container. In response to receiving the return instruction for the current live streaming room page, the page data corresponding to the immediately-previous-level page of the current live streaming room page in the storage container can be queried, thereby returning to the immediately-previous-level page.

Further, the storage container can store both the page data corresponding to the live streaming room page and the page data corresponding to the web page. That is, both the jump operation and the return operation between the live streaming room page and the web page can be achieved.

In a possible implementation according to an embodiment of the present disclosure, the page data in the storage container is sequentially stored based on a page level order, in response to each jump from a previous-level page.

In some embodiments, the page data is stored based on the page level order, and the data of the immediately-previous-level page corresponding to the page to be returned from may be returned to for each return.

In some embodiments, after returning to the immediately-previous-level page, the user may interact with it by swiping up or down. For example, when the immediately-previous-level page is a live streaming room page, the user may swipe up on the live streaming room page to return to its previous-level live streaming room page, or swipe down on the live streaming room page to switch to its next-level live streaming room page. As another example, when the immediately-previous-level page is a web page, the user may swipe up or down to scroll up or down the web page.

In a possible implementation according to an embodiment of the present disclosure, the method further includes: (1) displaying a return control on a current live streaming room page, the return control being configured to trigger the return instruction; and (2) hiding the return control when a display time period of the current live streaming room page exceeds a predetermined time period.

In some embodiments, when the display time period of the current live streaming room page exceeds the predetermined time period, the user may be interested in a live streaming content of the current live streaming room page, and the return control may be hidden. For example, when a display time period of the current live streaming room page exceeds 60 seconds, a return control at an upper left corner is hidden.

Instead of being hidden suddenly, the return control may disappear gradually. For example, when the display time period of the current live streaming room page exceeds 30 seconds, the return control at the upper left corner shrinks by a certain degree, for example, by a quarter, a half, etc. Then, when the display time period of the current live streaming room page exceeds 60 seconds, the return control at the upper left corner disappears completely, i.e., it is hidden.

In some embodiments, even if the return control is hidden, the user can still trigger the return instruction, e.g., through a swipe gesture.

In some embodiments, the current live streaming room page may be provided with both a first return control that can be hidden and a second return control that is constantly displayed. The first return control and the second return control are displayed at different positions on the the current live streaming room page and/or in different forms. In this case, even if the first return control has been hidden, the user can still trigger the return instruction by operating the second return control.

In some embodiments, the immediately-previous-level page of the current live streaming room page is of the same type as the current live streaming room page. Between the same type of pages, there may be one or more pages of a different type. For example, both the current live streaming room page and its same type of immediately-previous-level page are live streaming room pages, and a web page between them can be skipped when returning from the current live streaming room page directly to its immediately-previous-level live streaming room page. Similarly, from an immediately-next-level page of the same type as the current live streaming room page (i.e., the immediately-next-level live streaming room page of the current live streaming room page), the user can directly return to the current live streaming room page, by skipping a web page.

By way of example, referring again to FIG. 3, suppose the current live streaming room page is the third-level live streaming room page. In this case, the user can return from the third-level live streaming room page directly to the first-level live streaming room page by clicking a specific return control or performing a specific gesture. For example, the third-level live streaming room page may be provided with the first return control that can be hidden and/or the second return control that is constantly displayed. When the user clicks the first return control or the second return control, the third-level live streaming room page directly returns to the first-level live streaming room page, without having to first returning to the second-level web page. Likewise, the first-level live streaming room page may be provided with the first return control and/or the second return control, so that the user can return from the first-level live streaming room page directly to its previous-level live streaming room page by clicking one of the return controls.

As compared with returning from the third-level live streaming room page to the second-level web page first and then to the first-level live streaming room page, the scheme of returning from the third-level live streaming room page directly to the first-level live streaming room page simplifies the user's operation and saves time, by skipping the second-level web page.

In a possible implementation according to an embodiment of the present disclosure, the method further includes: dragging, in response to receiving a swipe gesture for the current live streaming room page and a swipe speed of the swipe gesture being smaller than a predetermined threshold, the current live streaming room page on a display interface based on the swipe gesture.

In some embodiments, when it is detected that the swipe speed of the swipe gesture is smaller than the predetermined threshold, it is indicated that the user may not mean to trigger the return or jump instruction, but may intend to adjust a display effect of the current live streaming room page. In this case, the current live streaming room page can be dragged on the display interface based on the swipe gesture.

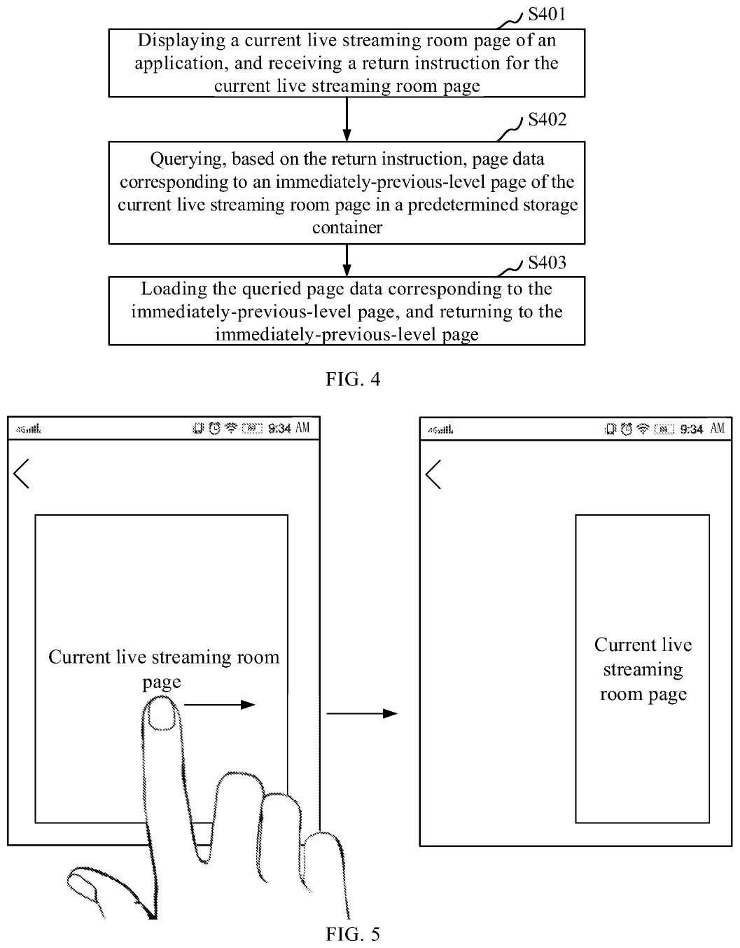

As illustrated in FIG. 5, with a rightward/leftward swipe gesture of the user and a swipe speed of a swipe gesture being smaller than the predetermined threshold, a current live streaming room page 501 slides rightwards/leftwards on the display interface, and a pure color or predetermined background image may be displayed on a left/right side.

In some embodiments, when the current live streaming room page is completely dragged out of the display page, the jump instruction may be triggered to perform jumping.

According to the above-mentioned live streaming room page return method, the page data of the one or more previous-level pages of the current live streaming room page is stored in the storage container, and the page data corresponding to the immediately-previous-level page of the current live streaming room page in the storage container can be queried in response to receiving the return instruction for the current live streaming room page, thereby returning to the immediately-previous-level page.

Further, the storage container can store both page data corresponding to the live streaming room page and page data corresponding to the web page. That is, both the jump operation and the return operation between the live streaming room page and the web page can be achieved.

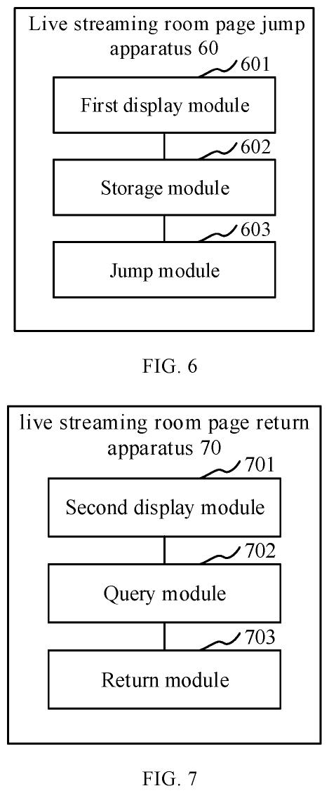

According to an embodiment of the present disclosure, a live streaming room page jump apparatus is provided. As illustrated in FIG. 6, a live streaming room page jump apparatus 60 may include: a first display module 601, a storage module 602, and a jump module 602. The first display module 601 is configured to display a current live streaming room page of an application and receive a jump instruction of jumping to an immediately-next-level page. The storage module 602 is configured to store page data corresponding to the current live streaming room page in a predetermined storage container. The jump module 603 is configured to jump to the corresponding immediately-next-level page based on the jump instruction.

In a possible implementation according to an embodiment of the present disclosure, when the page data corresponding to the current live streaming room page is stored in the predetermined storage container, the storage module 602 is specifically configured to: store the page data corresponding to the current live streaming room page into the storage container based on a page level order corresponding to the current live streaming room page.

In a possible implementation according to an embodiment of the present disclosure, the immediately-next-level page is a live streaming room page or a web page; and the storage container is configured to store page data corresponding to the live streaming room page and page data corresponding to the web page.

In a possible implementation according to an embodiment of the present disclosure, the immediately-next-level page is a live streaming room page; and in response to jumping to the corresponding immediately-next-level page based on the jump instruction, the jump module 603 is specifically configured to: determine a screen display state of the current live streaming room page; and jump to the corresponding immediately-next-level page based on the jump instruction, and display the immediately-next-level page based on the determined screen display state.

According to the above-mentioned live streaming room page return apparatus, the page data corresponding to the current live streaming room page is stored in the predetermined storage container, and the page data is used to return to the current page in response to receiving the return instruction for the immediately-next-level page, such that the immediately-next-level page can return to the current live streaming room page prior to the page jump.

Further, the storage container can store both the page data corresponding to the live streaming room page and the page data corresponding to the web page. That is, both the jump operation and the return operation between the live streaming room page and the web page can be achieved.

The live streaming room page jump apparatus of a picture according to the present disclosure can perform a live streaming room page jump method of a picture according to the embodiments of the present disclosure, and both the live streaming room page jump apparatus and method thereof are similar in their implementation principle. The action performed by each module in the live streaming room page jump apparatus of the picture according to the embodiments of the present disclosure corresponds to the steps in the live streaming room page jump method of the picture in the embodiments of the present disclosure. Detailed description for the functions of each module of the live streaming room page jump apparatus of the picture can be specifically referred to that corresponding to the live streaming room page jump method of the picture above mentioned, which will not be repeated herein.

According to an embodiment of the present disclosure, a live streaming room page return apparatus is provided. As illustrated in FIG. 7, the live streaming room page return apparatus includes a second display module 701, a query module 702, and a return module 703. The second display module 701 is configured to display a current live streaming room page of an application and receive a return instruction for the current live streaming room page. The query module 702 is configured to query, based on the return instruction, page data corresponding to an immediately-previous-level page of the current live streaming room page in a predetermined storage container. The storage container is configured to store page data of one or more previous-level pages of the current live streaming room page. The return module 703 is configured to load the queried page data corresponding to the immediately-previous-level page and return to the immediately-previous-level page.

In a possible implementation according to an embodiment of the present disclosure, the page data in the storage container is sequentially stored based on a page level order, in response to each jump from a previous-level page.

In a possible implementation according to an embodiment of the present disclosure, the immediately-previous-level page is a live streaming room page or a web page; and the storage container is configured to store page data corresponding to the live streaming room page and the page data corresponding to the web page.

In a possible implementation according to an embodiment of the present disclosure, the apparatus further includes a hiding module configured to: display a return control on the current live streaming room page, the return control being configured to trigger the return instruction; and hide the return control when a display time period of the current live streaming room page exceeds the predetermined period.

In a possible implementation according to an embodiment of the present disclosure, the apparatus further includes a swipe module configured to: drag, in response to receiving a swipe gesture for the current live streaming room page and a swipe speed of the swipe gesture being smaller than a predetermined threshold, the current live streaming room page on a display interface based on the swipe gesture.

The live streaming room page jump apparatus of a picture according to the present disclosure can perform a live streaming room page jump method of a picture according to the embodiments of the present disclosure, and both the live streaming room page jump apparatus and method thereof are similar in their implementation principle. The action performed by each module in the live streaming room page jump apparatus of the picture according to the embodiments of the present disclosure corresponds to the steps in the live streaming room page jump method of the picture in the embodiments of the present disclosure. Detailed description for the functions of each module of the live streaming room page jump apparatus of the picture can be specifically referred to that corresponding to the live streaming room page jump method of the picture above mentioned, which will not be repeated herein.

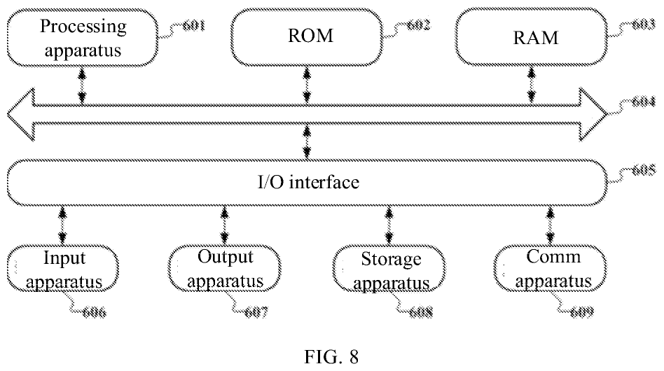

FIG. 8 is a schematic diagram illustrating a structure of an electronic device 600 adapted to implement the embodiments of the present disclosure. The electronic device according to the embodiments of the present disclosure may include, but is not limited to, a mobile terminal such as a mobile phone, a laptop computer, a digital broadcast receiver, a Personal Digital Assistant (PDA), a tablet computer or PAD, a Portable Multimedia Player (PMP), a vehicle terminal (e.g., a vehicle-mounted navigation terminal), or a fixed terminal such as a digital TV, a desktop computer, etc. The electronic device illustrated in FIG. 8 is exemplary only, and should not be construed as limiting the function and scope of use of the embodiments of the present disclosure.

The electronic device includes a memory and a processor. The processor herein may be referred to as a processing apparatus 601 hereinafter, and the memory herein may include at least one of a Read Only Memory (ROM) 602, a Random Access Memory (RAM) 603, or a storage apparatus 608, which are described in details as follows.

As illustrated in FIG. 8, the electronic device 600 may include the processing apparatus 601 (e.g., a central processing unit, a graphics processor, etc.), which may perform various appropriate actions and processes in accordance with programs stored in a Read Only Memory (ROM) 602 or loaded from the storage apparatus 608 into the random access memory (RAM) 603. Various programs and data required for operation of the electronic device 600 may also be stored on the RAM 603. The processing device 601, the ROM 602, and the RAM 603 are connected to each other through a bus 604. An input/output (I/O) interface 605 is also connected to bus 604.

Generally, the following apparatuses may be connected to the I/O interface 605: an input apparatus 606 including, for example, a touch screen, a touch pad, a keyboard, a mouse, a camera, a microphone, an accelerometer, a gyroscope, etc.; an output apparatus 607 including, for example, a Liquid Crystal Display (LCD), a speaker, a vibrator, etc.; a storage apparatus 608 including, for example, magnetic tape, hard disk, etc.; and a communication apparatus 609. The communication apparatus 609 may allow the electronic device 600 to perform wireless or wired communication with other devices to exchange data. Although FIG. 8 illustrates the electronic device 600 having various means, it can be appreciated that it is not necessary to implement or provide all the illustrated devices. Alternatively, more or fewer devices may be implemented or provided.

In particular, according to an embodiment of the present disclosure, the processes described above with reference to the flowcharts may be implemented as computer software programs. For example, an embodiment of the present disclosure includes a computer program product, which includes a computer program carried on a computer-readable medium. The computer program includes program codes for implementing the method illustrated in any of the flowcharts. In these embodiments, the computer program may be downloaded and installed from a network through the communication apparatus 609, or installed from the storage apparatus 608, or installed from the ROM 602. When the computer program is executed by the processing apparatus 601, the above-mentioned functions defined in the methods according to the embodiments of the present disclosure are performed.

It is to be noted that the above computer-readable medium in the present disclosure may be a computer-readable signal medium or a computer-readable storage medium or any combination thereof. The computer-readable storage medium may be, but not limited to, for example, an electrical, magnetic, optical, electromagnetic, infrared, or semiconductor system, apparatus, or device, or any combination thereof. More specific examples of the computer-readable storage medium may include, but not limited to: an electrical connection having one or more wires, a portable computer disk, a hard disk, a Random Access Memory (RAM), a Read Only Memory (ROM), an Erasable Programmable Read Only Memory (EPROM) or a flash memory, an optical fiber, a Compact Disc Read-Only Memory (CD-ROM), an optical memory device, a magnetic memory device, or any suitable combination thereof. In the present disclosure, the computer-readable storage medium may be any tangible medium including or storing programs, which may be used by or used with an instruction execution system, apparatus, or device. However, in the present disclosure, the computer-readable signal medium may include a data signal propagated in a baseband or as a part of a carrier that carries computer-readable program codes. Such propagated data signal may be in various forms, including but not limited to an electromagnetic signal, an optical signal, or any suitable combination thereof. The computer-readable signal medium may be any computer-readable medium other than the computer-readable storage medium, which may transmit, propagate, or transfer programs used by or used with an instruction execution system, apparatus or device. The program codes contained on the computer-readable medium may be transmitted via any appropriate medium, including but not limited to electric cable, optical cable, Radio Frequency (RF), or any suitable combination thereof.

In some embodiments, the client and the server may communicate using any currently known or future-developed network protocol, such as HTTP (HyperText Transfer Protocol), and may be in interconnection with digital data communication in any form or medium (e.g., a communication network). Examples of communication networks include a Local Area Network (“LAN”), a Wide Area Network (“WAN”), the Internet work (e.g., the Internet), and an end-to-end network (e.g., ad hoc end-to-end network), as well as any currently known or future-developed network.

The above-mentioned computer readable medium may be contained in the above-mentioned electronic device, or it may be separated and not assembled into the electronic device.

The above-mentioned computer readable medium can carry one or more programs. The one or more programs, when executed by the electronic device, allow the electronic device to: display a current live streaming room page of an application, and receive a jump instruction of jumping to an immediately-next-level page; store page data corresponding to the current live streaming room page into a predetermined storage container, the page data being used to return to the current live streaming room page in response to receiving a return instruction for the immediately-next-level page; and jumping to the corresponding immediately-next-level page based on the jump instruction.

The above-mentioned computer readable medium can carry one or more programs. The one or more programs, when executed by the electronic device, allow the electronic device to: display a current live streaming room page of an application, and receive a return instruction for the current live streaming room page; query, based on the return instruction, page data corresponding to an immediately-previous-level page of the current live streaming room page in a predetermined storage container, the storage container being configured to store page data of one or more previous-level pages of the current live streaming room page; and load the queried page data corresponding to the immediately-previous-level page, and return to the immediately-previous-level page.

The computer program codes for implementing the operations according to the embodiments of the present disclosure may be written in one or more programming languages or any combination thereof. The programming languages may include object-oriented programming languages, such as Java, Smalltalk, or C++, as well as conventional procedure-oriented programming languages, such as “C” language or similar programming languages. The program codes may be executed completely on a user computer, partly on the user computer, as a standalone software package, partly on the user computer and partly on a remote computer, or completely on the remote computer or server. In a case where the remote computer is involved, the remote computer may be connected to the user computer through any types of network, including a Local Area Network (LAN) or a Wide Area Network (WAN), or to an external computer (e.g., over the Internet by using an Internet service provider).

The flowcharts and block diagrams in the accompanying drawings illustrate architectures, functions, and operations of possible implementations of systems, methods, and computer program products according to various embodiments of the present disclosure. In this regard, each block in the flowcharts or block diagrams may represent a module, a program segment, or a part of codes. The module, program segment, or part of codes may contain one or more executable instructions for implementing a specified logical function. It should also be noted that, in some alternative implementations, the functions showed in blocks may occur in an order other than the order illustrated in the drawings. For example, two blocks illustrated in succession may actually be executed substantially in parallel with each other, or sometimes even in a reverse order, depending on functions involved. It should also be noted that each block in the block diagrams and/or flowcharts, or any combination of the blocks in the block diagrams and/or flowcharts, may be implemented using a dedicated hardware-based system configured to perform specified functions or operations or may be implemented using a combination of dedicated hardware and computer instructions.

The modules or units described in the embodiments of the present disclosure may be embodied as software or hardware. The names of the modules or units do not constitute a limit to the units themselves, for example, the jump module may also be described as “a module configured to jump to an immediately-next-level page”.

The functions described herein above may be performed, at least in part, by one or more hardware logic components. For example, without limitation, exemplary types of suitable hardware logic components include a Field Programmable Gate Array (FPGA), an Application Specific Integrated Circuit (ASIC), an Application Specific Standard Product (ASSP), a System on Chip (SOC), a Complex Programmable Logic Device (CPLD), and the like.

In the context of this disclosure, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of a machine-readable storage medium would include an electrical connection having one or more wires, a portable computer disk, a hard disk, a Random Access Memory (RAM), a Read Only Memory (ROM), an Erasable Programmable Read Only Memory (EPROM) or flash memory, an optical fiber, a Compact Disc Read Only Memory (CD-ROM), an optical memory device, a magnetic memory device, or any suitable combination thereof.

According to one or more embodiments of the present disclosure, a live streaming room page jump method is provided. The live streaming room page jump method includes: displaying a current live streaming room page of an application, and receiving a jump instruction of jumping to an immediately-next-level page; storing page data corresponding to the current live streaming room page into a predetermined storage container, the page data being used to return to the current live streaming room page in response to receiving a return instruction for the immediately-next-level page; and jumping to the corresponding immediately-next-level page based on the jump instruction.

According to one or more embodiments of the present disclosure, the operation of storing the page data corresponding to the current live streaming room page into the predetermined storage container includes: storing the page data corresponding to the current live streaming room page into the storage container based on a page level order corresponding to the current live streaming room page.

According to one or more embodiments of the present disclosure, the immediately-next-level page is a live streaming room page or a web page; and the storage container is configured to store page data corresponding to the live streaming room page and page data corresponding to the web page.

According to one or more embodiments of the present disclosure, the immediately-next-level page is a live streaming room page; and the operation of jumping to the corresponding immediately-next-level page based on the jump instruction includes: determining a screen display state of the current live streaming room page; and jumping to the corresponding immediately-next-level page based on the jump instruction, and displaying the immediately-next-level page based on the determined screen display state.

According to one or more embodiments of the present disclosure, a live streaming room page return method is provided. The live streaming room page return method includes: displaying a current live streaming room page of an application, and receiving a return instruction for the current live streaming room page; querying, based on the return instruction, page data corresponding to an immediately-previous-level page of the current live streaming room page in a predetermined storage container, the storage container being configured to store the page data of one or more previous-level pages of the current live streaming room page; and loading the queried page data corresponding to the immediately-previous-level page, and returning to the immediately-previous-level page.

According to one or more embodiments of the present disclosure, the page data in the storage container is sequentially stored based on a page level order, in response to each jump from a previous-level page.

According to one or more embodiments of the present disclosure, the immediately-previous-level page is a live streaming room page or a web page; and the storage container is configured to store page data corresponding to the live streaming room page and page data corresponding to the web page.

According to one or more embodiments of the present disclosure, the live streaming room page return method further includes: displaying a return control on the current live streaming room page, the return control being configured to trigger the return instruction; and hiding the return control when a display time period of the current live streaming room exceeds a predetermined time period.

According to one or more embodiments of the present disclosure, the live streaming room page return method further includes: dragging, in response to receiving a swipe gesture for the current live streaming room page and a swipe speed of the swipe gesture being smaller than a predetermined threshold, the current live streaming room page on a display interface based on the swipe gesture.

According to one or more embodiments of the present disclosure, a live streaming room page jump apparatus is provided. The live streaming room page jump apparatus includes: a first display module configured to display a current live streaming room page of an application and receive a jump instruction of jumping to an immediately-next-level page; a storage module configured to store page data corresponding to the current live streaming room page in a predetermined storage container; and a jump module configured to jump to the corresponding immediately-next-level page based on the jump instruction.

According to one or more embodiments of the present disclosure, a live streaming room page return apparatus is provided. The live streaming room page return apparatus includes: a second display module configured to display a current live streaming room page of an application and receive a return instruction for the current live streaming room page; and a query module configured to query, based on the return instruction, page data corresponding to an immediately-previous-level page of the current live streaming room page in a predetermined storage container, the storage container being configured to store page data of one or more previous-level pages of the current live streaming room page; and a return module configured to load the queried page data corresponding to the immediately-previous-level page and return to the immediately-previous-level page.

According to one or more embodiments of the present disclosure, an electronic device is provided. The electronic device includes: one or more processors; a memory; and one or more application programs. The one or more application programs are stored in the memory, and are configured to be executed by the one or more processors to perform the live streaming room page jump method according to any one of the above-mentioned disclosures.

According to one or more embodiments of the present disclosure, an electronic device is provided. The electronic device includes: one or more processors; a memory; and one or more application programs. The one or more application programs are stored in the memory, and are configured to be executed by the one or more processors to perform the live streaming room page return method according to any one of the above-mentioned disclosures.

According to one or more embodiments of the present disclosure, a computer-readable medium is provided. The computer-readable medium has a computer program stored thereon. The computer program, when executed by a processor, implements the live streaming room page jump method according to any one of the above-mentioned disclosures.

According to one or more embodiments of the present disclosure, a computer-readable medium is provided. The computer-readable medium has a computer program stored thereon. The computer program, when executed by a processor, implements the live streaming room page return method according to any one of the above-mentioned disclosures.

The above description is only intended to explain the preferred embodiments of the present disclosure and the employed principles of the technology. It will be appreciated by those skilled in the art that the scope of the present disclosure herein is not limited to t the technical solutions formed by the specific combination of the above technical features, but should also encompass any other combinations of features described above or equivalents thereof without departing from the above concept of the present disclosure. For example, the above features and the technical features disclosed in the present disclosure having similar functions (but not limited to them) are replaced with each other to form the technical solution.

Further, although the operations are depicted in a specific order, this should not be understood as requiring these operations to be performed in the specific order illustrated or in a sequential order. Under certain circumstances, multitasking and parallel processing may be advantageous. Likewise, although several specific implementation details are included in the above discussion, these should not be construed as limitations on the scope of the present disclosure. Certain features that are described in the context of separate embodiments can also be implemented in combination in a single embodiment. Conversely, various features described in the context of a single embodiment can also be implemented in multiple embodiments separately or in any suitable combination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

What is claimed is:

1. A live streaming room page jump method, comprising:
displaying a current live streaming room page of an application, and receiving a jump instruction of jumping to an immediately-next-level page;
storing page data corresponding to the current live streaming room page into a predetermined storage container, the page data being used for returning to the current live streaming room page in response to receiving a return instruction for the immediately-next-level page; and
jumping to the corresponding immediately-next-level page based on the jump instruction.

2. The live streaming room page jump method according to claim 1, wherein said storing the page data corresponding to the current live streaming room page into the predetermined storage container comprises:
storing the page data corresponding to the current live streaming room page into the storage container based on a page level order corresponding to the current live streaming room page.

3. The live streaming room page jump method according to claim 1, wherein:
the immediately-next-level page is a live streaming room page or a web page; and
the storage container is configured to store page data corresponding to the live streaming room page and page data corresponding to the web page.

4. The live streaming room page jump method according to claim 1, wherein:
the immediately-next-level page is a live streaming room page; and
said jumping to the corresponding immediately-next-level page based on the jump instruction comprises:
determining a screen display state of the current live streaming room page; and
jumping to the corresponding immediately-next-level page based on the jump instruction, and displaying the immediately-next-level page based on the determined screen display state.

5. The live streaming room page jump method according to claim 1, wherein
the page data corresponding to the current live streaming room page is also used for returning from an immediately-next-level live streaming room page of the current live streaming room page to the current live streaming room page, in response to receiving a return instruction for the immediately-next-level live streaming room page.

6. A live streaming room page return method, comprising:
displaying a current live streaming room page of an application, and receiving a return instruction for the current live streaming room page;
querying, based on the return instruction, page data corresponding to an immediately-previous-level page of the current live streaming room page in a predetermined storage container, the storage container being configured to store page data of one or more previous-level pages of the current live streaming room page; and
loading the queried page data corresponding to the immediately-previous-level page, and returning to the immediately-previous-level page.

7. The live streaming room page return method according to claim 6, wherein the page data in the storage container is sequentially stored based on a page level order, in response to each jump from a previous-level page.

8. The live streaming room page return method according to claim 6, wherein:
the immediately-previous-level page is a live streaming room page or a web page; and
the storage container is configured to store page data corresponding to the live streaming room page and page data corresponding to the web page.

9. The live streaming room page return method according to claim 6, further comprising:
displaying a return control on the current live streaming room page, the return control being configured to trigger the return instruction; and
hiding the return control when a display time period of the current live streaming room exceeds a predetermined time period.

10. The live streaming room page return method according to claim 6, further comprising:
dragging, in response to receiving a swipe gesture for the current live streaming room page and a swipe speed of the swipe gesture being smaller than a predetermined threshold, the current live streaming room page on a display interface based on the swipe gesture.

11. The live streaming room page return method according to claim 6, wherein the immediately-previous-level page of the current live streaming room page is an immediately-previous-level live streaming room page of the current live streaming room page.

12. An electronic device, comprising:
one or more processors;
a memory; and
one or more application programs, wherein the one or more application programs are stored in the memory, and are configured to be executed by the one or more processors to perform a live streaming room page jump method comprising:
displaying a current live streaming room page of an application, and receiving a jump instruction of jumping to an immediately-next-level page;
storing page data corresponding to the current live streaming room page into the memory, the page data being used for returning to the current live streaming room page in response to receiving a return instruction for the immediately-next-level page; and
jumping to the corresponding immediately-next-level page based on the jump instruction.

13. The electronic device according to claim 12, wherein:
the immediately-next-level page is a live streaming room page or a web page; and
the memory is configured to store page data corresponding to the live streaming room page and page data corresponding to the web page.

14. The electronic device according to claim 12, wherein:
the immediately-next-level page is a live streaming room page; and
said jumping to the corresponding immediately-next-level page based on the jump instruction comprises:
determining a screen display state of the current live streaming room page; and
jumping to the corresponding immediately-next-level page based on the jump instruction, and displaying the immediately-next-level page based on the determined screen display state.

15. The electronic device according to claim 12, wherein
the page data corresponding to the current live streaming room page is also used for returning from an immediately-next-level live streaming room page of the current live streaming room page to the current live streaming room page, in response to receiving a return instruction for the immediately-next-level live streaming room page.

16. An electronic device, comprising:
one or more processors;
a memory; and
one or more application programs, wherein the one or more application programs are stored in the memory, and are configured to be executed by the one or more processors to perform the live streaming room page return method according to claim 5.

17. The electronic device according to claim 16, wherein:
the immediately-previous-level page is a live streaming room page or a web page; and
the storage container is configured to store page data corresponding to the live streaming room page and page data corresponding to the web page.

18. The electronic device according to claim 16, wherein the live streaming room page return method further comprises:
displaying a return control on the current live streaming room page, the return control being configured to trigger the return instruction; and
hiding the return control when a display time period of the current live streaming room exceeds a predetermined time period.

19. The electronic device according to claim 16, wherein the live streaming room page return method further comprises:
dragging, in response to receiving a swipe gesture for the current live streaming room page and a swipe speed of the swipe gesture being smaller than a predetermined threshold, the current live streaming room page on a display interface based on the swipe gesture.

20. The electronic device according to claim 16, wherein the immediately-previous-level page of the current live streaming room page is an immediately-previous-level live streaming room page of the current live streaming room page.
